(19) United States
(12) Patent Application Publication
(10) Pub. No.: US 2009/0270249 A1
(43) Pub. Date: Oct. 29, 2009

(54) METHOD FOR FORMING A CATALYST CARRIER

(76) Inventors: Stephen L. Dahar, Solon, OH (US); Douglas M. Korwin, Copley, OH (US); Samuel M. Koch, Cuyahoga Falls, OH (US); Ralph Bauer, Niagara Falls (CA); Thomas Szymanski, Hudson, OH (US)

Correspondence Address: SAINT-GOBAIN NORPRO, 3840 FISHCREEK ROAD, STOW, OH, 44224, US

(21) Appl. No.: 12/433,013

(22) Filed: Apr. 30, 2009

Related U.S. Application Data
(62) Division of application No. 11/078,553, filed on Mar. 11, 2005, now abandoned.
(60) Provisional application No. 60/552,921, filed on Mar. 12, 2004.

(51) Int. Cl. B01J 21/08; B01J 21/04

(52) U.S. Cl. 502/242; 502/439

(57) ABSTRACT

A method of forming a carrier material suited to use in Fischer-Tropsch reactions includes forming a dispersion of first and second hydrated alumina materials in a liquid dispersant, such as an acid solution. The first alumina can be derived from an alkali aluminate, such as is formed in the Bayer reaction. The second hydrated alumina can be derived from high purity aluminum, such as via conversion to an alkoxide. The dispersion is spray dried to form particles which are heat treated to form a carrier material having low levels of impurities.

This application claims the benefit of U.S. Provisional Application No. 60/552,921, filed Mar. 12, 2004, the disclosure of which is incorporated herein in its entirety by reference.

### BACKGROUND

1. Field of the Invention

The invention relates to a spray dried alumina catalyst carrier. It finds particular application in conjunction with catalysts for promoting Fischer-Tropsch reactions, and will be described with particular reference thereto. However, it is to be appreciated that the present exemplary embodiment is also amenable to other like applications.

2. Discussion of the Art

Hydrated aluminas having a boehmite or pseudoboehmite type of structure find application in the manufacture of catalysts due to their relatively high surface area and pore structure. Boehmites have a characteristic interplanar distance (020) of about 6.15 Angstroms (61.5 nanometers) and essentially no X-ray diffraction in the 6.5-6.8 A range. Pseudoboehmites are hydrated aluminas which are primarily amorphous in character and have a characteristic interplanar distance (020) of about 6.5-6.8 Å.

U.S. Pat. No. 3,630,670 to Bell, et al. (the '670 patent) describes a process for preparing hydrated alumina (Al₂O₃.H₂O) of a substantially pseudoboehmite structure which, owing to its large surface area, high pore volume, and pore size distribution, is suitable as support material for catalysts. The process involves mixing a sodium aluminate solution with a strong acid, such as nitric acid in a first reactor and quickly transferring the mixture to a second reactor where a slurry of the hydrated alumina forms. A portion of the slurry is recycled back to the first reactor. The resulting alumina is washed to remove impurities of Na₂O and spray dried. The '670 patent is incorporated herein by reference, in its entirety.

Two disadvantages of this production process are that the product formed is not spherical and often has residual impurities. Impurities, such as Na₂O, are undesirable in many catalyst carriers because the impurity tends to migrate to the catalytic surface and deactivate the catalyst.

The sodium aluminate for the above process can be obtained by dissolving alumina trihydrate, such as that produced by the Bayer process, in a sodium hydroxide solution. Alternatively, the sodium aluminate can be taken directly from the Bayer process step, in which bauxite is digested with sodium hydroxide.

Another process of preparation of alumina hydrates is by hydrolysis of aluminum alkoxides. The alkoxide is typically formed by reaction of metallic aluminum shavings with an alcohol. The alkoxide is filtered and reacted with water of a high purity to form hydrated alumina. The resulting material can be converted into a spherical form by spray drying. The purity of the alumina hydrate formed by the alkoxide method is generally higher than that formed in the aluminate method described above. However, the process requires relatively complex equipment and extremely pure reagents so the cost of the alumina hydrate tends to be relatively high.

The present embodiment provides a new and improved method of preparing a catalyst support material based on alumina hydrate.

### BRIEF DESCRIPTION

In accordance with one aspect of the present exemplary embodiment, a method of forming a carrier material is provided. The method includes forming a dispersion of a first hydrated alumina and a second, different hydrated alumina material in a liquid dispersant. The dispersion is spray dried to form particles. The spray dried particles are heated to form the carrier material. The first hydrated alumina may differ from the second hydrated alumina in at least one of its surface area and the concentration of at least one impurity. The dispersion may be formed by forming a dispersion of the first hydrated alumina and adding the second hydrated alumina to that dispersion, either in the form of another dispersion or as a powder.

In accordance with another aspect of the present embodiment, a spray dried carrier material is provided. The carrier material includes at least 95% by weight alumina and has a pore volume, as measured by a BET method with nitrogen of at least 0.7 m²/g, a median pore diameter of about 10-20 nm, and at sodium, measured as its oxide, of less than about 200 ppm.

In accordance with another aspect of the present embodiment, a carrier material is provided. The carrier material includes at least 95% by weight alumina, at least 90% of the alumina being gamma alumina. The carrier material has a surface area of at least 100 m²/g and an attrition loss, as measured according to ASTM 5757-00, over four hours, of less than 12%.

Surface areas are measured by a Brunauer, Emett, Teller (BET) method with nitrogen, unless otherwise noted. Pore volume measurements are by nitrogen absorption.

### DETAILED DESCRIPTION

An alumina-based catalyst support material or carrier is based on alumina hydrate (Al₂O₃.H₂O) which can be derived from two or more alumina starting materials. The support material typically comprises particles which are spherical or substantially spherical. It can have a chemical purity closer to alumina completely derived from aluminum alkoxide than that produced from an alkali aluminate or alumina trihydrate. The support material can comprise at least 90% alumina by weight, and in one embodiment, at least 99% alumina. The alumina present can be primarily in the gamma form (an alumina with a defect spinel type crystal structure which is cubic and has a space group of 227). The support material typically has an attrition resistance which is higher than that which is found in support materials completely derived from aluminum alkoxide.

In one embodiment, the support material comprises alumina derived from first and second hydrated alumina materials. The first hydrated alumina material may be formed in a process starting principally with an alkali aluminate derived from alumina trihydrate (sometimes referred to as aluminum trihydroxide) or bauxite, but is not limited to these sources. The second alumina material may be formed in a process which starts principally with pure aluminum metal. Both hydrated aluminas can have a pseudoboehmite structure, i.e., are hydrated aluminas which are primarily amorphous in character and have a characteristic interplanar distance (020) of about 6.5-6.8 Å. The first hydrated alumina material can be higher in one or more impurities than the second hydrated alumina material. Both the first and second hydrated alumina materials comprise primarily alumina hydrate, generally at least 95% alumina hydrate, by weight, and in one embodiment, at least 99% alumina hydrate by weight. As impurities, both alumina hydrates can include, for example, alkali and alkaline earth metals, such as sodium, calcium, magnesium, as well as silicon, iron, titanium and the like, generally in the form of the respective oxide. Both sodium and titanium levels can vary significantly from boehmite source to boehmite source with levels varying from 0 to 2000 ppm. In general, however, the alkali aluminate-derived alumina hydrate has higher levels of impurities.

For example, as shown in TABLE 1, the first and second hydrated aluminas may comprise as impurities, as measured by inductively coupled plasma (ICP), expressed in terms of the oxide:

TABLE 1

| Oxide | First Hydrated Alumina | | Second Hydrated Alumina |
|---|---|---|---|
| Na₂O | ≦400 | ppm | <50 ppm |
| K₂O | <200 | ppm | <50 ppm |
| CaO | <300 | ppm | <50 ppm |
| MgO | <300 | ppm | <50 ppm |
| SiO₂ | <400 | ppm | <50 ppm |
| Fe₂0₃ | <200 | ppm | <50 ppm |
| TiO₂ | <200 | ppm | <50 ppm |
| Total of these | 500-2000 | ppm | <350 ppm |
| impurities | | | |

As can be seen from TABLE 1, the sodium content, and levels of other impurities, of the first hydrated alumina can be substantially higher than that of the second hydrated alumina. Generally, the Na₂O content of the first hydrated alumina is >50 ppm, and is typically ≧100 ppm. In one embodiment, the Na₂O content is ≧200 ppm. The second hydrated alumina has a sodium content of less than 50 ppm, typically <30 ppm.

Although the carrier material can be formed exclusively from the first hydrated alumina material, in one embodiment, the first and second hydrated alumina materials may be employed in a ratio of from about 1:99 to 99:1 parts by weight of the first hydrated alumina material to the second hydrated alumina material. In one embodiment, the ratio is at least 10:90, and in another embodiment, the ratio is at least 50:50. In one specific embodiment, the ratio is about 80:20. Because the ratios remain largely the same in the finished product, and the support material can be essentially all alumina, the support material formed can comprise from 1-99% of its weight derived from the first hydrated alumina (derived from alkali aluminate or alumina trihydrate) and 99-1% derived from the second hydrated alumina (derived from an alkoxide). In one embodiment, the support material comprises at least 50% by weight derived from the first hydrated alumina and in one specific embodiment, about 80% by weight is derived from the first hydrated alumina. Where the support material is formed with a substantial portion of its weight which is not alumina, the alumina portion can be at least 50% by weight derived from the first hydrated alumina and in one specific embodiment, about 80% by weight derived from the first hydrated alumina.

### The First Hydrated Alumina

The first hydrated alumina can have a mean particle size (diameter) of 0.05-50 microns. Particle sizes are as measured by a Horiba LA 300 particle size analyzer (laser light scattering), unless otherwise stated. In one embodiment, the mean diameter is less than 20 microns, in one specific embodiment, about 3-15 microns. The particles can be spherical or non-spherical, such as needle shaped. The surface area can be from 75 to 350 m²/g and the pore volume, 0.4-2.0 cc/g, e.g., 0.5 to 1.5 cc/g. In one embodiment, the pore volume is at least 0.7 cc/g.

The first hydrated alumina material can be formed from an alkali aluminate or alumina trihydrate. In one method, alkali aluminate is obtained from an aluminous ore, such as bauxite, via the Bayer process. In this process, bauxite is digested with a hot, caustic solution of a strong alkali, such as sodium hydroxide or potassium hydroxide. After separation of insoluble components, the resulting alkali aluminate-containing liquor (e.g., sodium aluminate in the case of sodium hydroxide) can be used directly to form alumina hydrate by reacting the alkali aluminate-containing liquor with an acid.

Alternatively, bauxite is digested with a hot, caustic solution of a strong alkali, such as sodium hydroxide or potassium hydroxide. After separation of insoluble components, the resulting alkali aluminate-containing liquor is allowed to cool, which causes precipitation of alumina trihydrate (e.g., as hydrargillite). Optionally additives may be added prior to cooling to reduce the level of undesirable impurities. The alumina trihydrate is filtered from the liquor and dried.

The alumina trihydrate is redissolved in a strong alkali, such as sodium hydroxide or potassium hydroxide, to form an alkali aluminate solution. An acid treatment step is then used to reprecipitate the alumina as alumina hydrate, in a similar manner to that for the directly-formed alkali aluminate.

The acid conversion of the alkali aluminate to alumina hydrate can be carried out in a variety of ways. In one method, the process of the '670 patent is used for forming the alumina hydrate of a substantially pseudoboehmite structure from the sodium aluminate solution. The process involves mixing the sodium aluminate solution with a strong acid, such as a mineral acid, acid in approximately stoichiometric amounts. Suitable mineral acids include nitric acid, sulfuric acid, and hydrochloric acid. The mixing step is carried out in a first reactor at a temperature of about 30° C.-70° C. and the mixture is continuously transferred to a second reactor (e.g., within about 1 minute of mixing), where a slurry of the alumina hydrate forms. The second reactor is maintained at a temperature of about 30° C.-75° C. and the reaction mixture is kept in this vessel for an average residence time of from about 10 to about 300 minutes. A portion of the slurry is recycled back to the first reactor. This recycle allows control of the porosity of the product. Generally, the higher the recycle percentage, the greater the pore volume. For example, pore volumes of about 0.1-0.5 cc/g can be obtained. The resulting alumina hydrate is washed to remove impurities of Na₂O and spray dried.

An example of a commercial product obtained by such a process is sold under the tradename Versal, e.g., Versal 200, Versal 250 and Versal 300 from UOP, Des Plaines, Ill. The product is a pseudoboehmite which readily converts to gamma alumina (an alumina with a tetragonal structure). Literature produced by the manufacturer indicates that the Versal 200 product has the following impurities, expressed as weight %: Na₂O 0.01 wt. %, SiO₂ 0.04 wt. %, Fe₂O₃ 0.01 wt. %, and Cl 0.04 wt. %. However, commercial samples often show higher levels of sodium oxide, typically 0.01-0.02 wt. %. The literature indicates that the material has a pore volume of over 1 cc/gm and a surface area of 320 m²/g after calcination at 600° C. The dispersibility index is said to be 20%. The dispersibility index is measured according to the La Roche test procedure which includes preparing a 100 mL slurry of the alumina material in water (4% by weight alumina) in a blender. 1 mL of 10N nitric acid is added. The blender is run at 13,000 rpm for five minutes. The slurry is transferred and a sedigraph plot is run immediately. The percent of alumina in the original sample that can be dispersed to less than 1 micron can be calculated from the cumulative mass percent at 1 micron and is termed the dispersibility index. The particle size, as measured with a Horiba analyzer, was 11.7 microns.

A similar product is available under the trade name HML-02, available from Hengmeilin Nanometer Chemical Industrial Material Company of Tianjin, P.R. China. This product is produced by a precipitation process and includes bayerite in addition to boehmite. The precipitation appears to yield a product with a lower purity than the Versal 200 product, however.

A second method for obtaining alumina hydrate suitable for use as the first hydrated alumina is by dissolution of a boehmite precursor in a dispersant, seeding the solution with boehmite seeds, and hydrothermally treating the solution to form a pseudoboehmite alumina hydrate, as described, for example, in U.S. application Ser. No. 10/414,590, filed Apr. 16, 2003, for Novel Boehmite Particles and Polymer Materials Incorporating Same, by Tang, et al., the disclosure of which is incorporated herein in its entirety, by reference. As disclosed in that application, the boehmite precursor can be an alumina trihydrate, such as bayerite or gibbsite, but it can also be finely crushed bauxite. It is also possible to use gamma alumina as the starting material. The dispersant promotes dissolution of the precursor and seeds and can be a mineral acid, such as those listed above, a base, such as KOH, NaOH, NH₄OH, or an organic amine. The boehmite seed particles act as nucleation sites around which boehmite, generated by conversion of the precursor, can crystallize.

For example, the boehmite precursor is first dispersed/suspended in water and heated at a temperature of from 100 to 300° C., and in one embodiment, from 150 to 250° C., in an autoclave at an autogeneously generated pressure of from 1×10⁵ to 8.5×10⁶ newtons/m² (e.g., 5×10⁵ to 1.2×10⁶ newtons/m²) for a period of from 1 to 24 hours (e.g., from 1 to 3 hours). The dispersion can comprise 5 to 40 wt. % boehmite precursor, and in one embodiment, from 10 to 30 wt. % boehmite precursor. The dispersion also comprises from 2 to 40 wt. % of boehmite seed particles, based on the weight of the precursor, in one embodiment, from 5 to 10 wt. % boehmite seed particles, based on the weight of the precursor. The dispersant may comprise HNO₃ present in the dispersion at about 2% by weight, based on the weight of precursor (about 5% by weight based on the weight of boehmite seeds). In the event an impure material, such as bauxite, is used as the boehmite precursor, it may be desirable to wash the product, to flush away impurities, such as silicon or titanium hydroxides.

The boehmite seed particles used in the second method may be produced by the method of the '670 patent or be an alkoxide-derived alumina hydrate, such as Catapal B pseudoboehmite obtainable from SASOL North America Inc., 900 Threadneedle, PO Box 19029, Houston Tex. 77224-9029.

The boehmite particles formed by the second method can be generally spherical, oblate, needle shaped, or platelet-shaped. Since the particles are typically milled to reduce their size after formation, the particle shape is not generally critical. For example, boehmite particles comprising needle-shaped (or anisotropic) crystals in which the longest dimension is at least 50 nanometers and can be from 50-2000 nm, e.g., from 100 to 1000 nm, are formed in a hydrothermal process. The crystals can have an aspect ratio, defined as the ratio of the longest dimension to the next largest dimension perpendicular to the length, of at least 3:1. In one embodiment, the aspect ratio is at least 6:1. The particles can have a surface area, as measured by the BET method, using nitrogen as the gas, of at least 75 m²/g. In one embodiment, the surface area of the particles is from 100-300 m²/g.

An example of such a product is CAM 90/10, supplied by Saint-Gobain Grains and Powders of Niagara Falls.

### The Second Hydrated Alumina

The second hydrated alumina can have a mean particle size (diameter) of about 10-100 microns (μ). In one embodiment, the mean diameter is about 40-50μ. The particles can be spherical or non-spherical. The surface area can be from about 100-300 m²/g and the pore volume, about 0.4-2.0 cc/gm. A suitable highly dispersible alumina for use as the second hydrated alumina is a pseudoboehmite that readily reacts with either a mineral or organic acid in a process called peptization.

The second hydrated alumina can be formed from pure aluminum (e.g., having a purity of at least 90%, in one embodiment, at least 95%, and in one specific embodiment, at least 99% pure aluminum). In this process, an alkoxide is formed by reaction of the metallic aluminum with an alcohol. Suitable alcohols include C₄-C₁₂ alcohols, such as hexanol. In one method, a reactor is filled with aluminum metal shavings and heated to a temperature of about 200° C. The alcohol is sprayed into the reactor, forming the alkoxide, aluminum hexoxide in the illustrated embodiment. The alkoxide is filtered and reacted with water of a high purity to form hydrated alumina. This step can be carried out in a separate reactor using a controlled amount of water. The resulting material can be converted into a spherical form by spray drying. The precipitated material can also be hydrothermally treated before spray drying to increase its pore volume. The purity of the alumina hydrate depends on the purity of the reagents used. By using high purity aluminum and water, the levels of impurities can be very low.

Such pseudoboehmites are obtained from Sasol North America Inc., under the tradenames Disperal, Dispal, Pural and Catapal, e.g., Catapal A, Catapal B, Pural 14, Pural HP 10, Pural SB, and the like. Similar products are also available from Southern Ionics. For example, Pural SB and Catapal A are indicated in trade literature as having sodium oxide impurity levels of less than 50 ppm, and generally about 20 ppm. SiO₂ is said to be 0.01-0.015%, Fe₂O₃ is 0.005-0.015%, and TiO₂ is 0.01-0.20%. Particle size (D(50)) is said to be about 45-60 μm. Surface area, as measured by BET after activation at 550° C. for three hours, is said to be about 250 m²/g. Pore volume is said to be about 0.5 ml/g, after activation at 550° C. for three hours.

Disperal has a water solubility of 97%, impurities: Na₂O is 0.002%, SiO₂ is 0.01-0.015%, Fe₂O₃ is 0.005-0.015%, and TiO₂ is 0.01-0.15%. Average particle size (D(50)) is about 45 μm. Surface area, as measured by BET after activation at 550° C. for three hours, is about 260 m²/g. Pore volume is about 0.5 ml/g, after activation at 550° C. for three hours.

### Formation of the Carrier

The carrier is formed by dispersing the two (or more) forms of hydrated alumina in a liquid dispersant, such as an acid/water solution and spray drying the mixture. The hydrated alumina reacts with the acid in a peptization reaction. While not fully understood, this reaction is thought to result in the formation of an alumina salt (aluminum oxynitrate, AlONO₃ in the case of nitric acid). The formation of the salt has a cross-linking effect, which raises the viscosity of the dispersion. The peptization reaction is generally not taken to completion since this raises the viscosity to a level at which the dispersion is not easily handled. In one embodiment, the peptization is allowed to proceed to a viscosity of about 300-10,000 cps as measured with a Brookfield viscometer with an LV2 spindle. Additionally, the dispersion process tends to form particles with fewer pores and lower surface area, if carried out for extensive periods.

Since dispersion rates and acid reactions (peptization) of different hydrated aluminas tend to differ, the two hydrated aluminas can be separately dispersed and the dispersions subsequently combined. For example, two suspensions are prepared, the first suspension consisting of a first hydrated alumina, such as an alumina trihydrate-derived alumina hydrate, together with water and an acid. The second suspension consists of the second hydrated alumina, such as highly dispersible, alkoxide-derived alumina, such as Dispersal, together with water and an acid. The acid can be added all at once, at the start, or stepwise.

The acid used in forming the two dispersions can be the same or different and can be at the same concentration or at different concentrations. Suitable acids include mineral acids, such as nitric acid, sulfuric acid, and hydrochloric acid, organic acids, such as formic acid, and combinations thereof. Of the mineral acids, preference is given to using nitric acid since it leaves behind no interfering decomposition products. Organic acids, such as formic acid, have advantages in that they do not generate nitrogen oxides when the product is heated. However, nitric acid also produces a high purity product. The make up water is preferably of high purity, such as distilled or deionized water. The acid can be at a molar ratio of acid to alumina of about 0.001 to about 0.1. When an organic acid is used, the molar ratio can be about 0.005 to 0.08. For inorganic acids, somewhat lower molar ratios can be effective, however, a range of from approximately 0.015 to 0.060 is generally most effective. The increased viscosity generated by peptization helps to hold the alumina material together during spray drying, to form particles of an appropriate size, pore volume, and pore size distribution. If the viscosity is too high, the material becomes difficult to work with. If the viscosity is too low, particles of the desired size tend not to be formed during spray drying.

The peptization can be carried out at a temperature of about room temperature (10-25° C.) or above. The temperature can be up to and including that at which hydrothermal reactions occur. In one embodiment, the reaction temperature is from 15 to 50° C. The total solids can be from about 1-35 wt %, e.g., about 25%, of which at least about 90% of the starting material is typically hydrated alumina. At this point, elements from groups IIA, IVA, IIIB, and IVB can be added, ether as soluble compounds or as oxide precursors, or as the oxides of these elements at about 0.1-10% by weight of the spray died product. The proportion of hydrated alumina in the suspension can be from about 1 to 50% by weight of the suspension. In one embodiment, the proportion of hydrated alumina in the suspension can be from about 20 to 30% by weight.

Each dispersion is mixed in a suitable mixer, such as a high intensity mixer (or a ball mill or other type of particle reduction device if particle size reduction is desired) for a sufficient time to achieve dispersion and convert at least some of the hydrated alumina to the corresponding alumina salt. For example, in the case of Versal 200, a suitable dispersion time may be about 1-8 hours, e.g., 2-4 hours. For a highly dispersible alumina, such as Dispersal, a suitable dispersion time may be from about 30 minutes to about 4 hrs.

In another embodiment, instead of dispersing the two hydrated aluminas separately, a dispersion can be formed of one of the hydrated aluminas, such as the first hydrated alumina. The dispersant can be as described above. Once the first alumina is at least partially dispersed, the second hydrated alumina is added in an undispersed form, e.g., as a powder or simply mixed with water. Dispersion of the combined hydrated aluminas can continue for a suitable period by mixing the combined dispersion. More acid can be added, if needed, when the second alumina is added, to ensure that the dispersion of both hydrated aluminas takes place.

To obtain a strong narrow particle size distribution of the dried support material it may be advantageous to subject the first or second alumina hydrate to milling prior to spray drying. This increases the proportion of fine particles in the mixture and also assists in the formation of spherical carrier particles. The milling can be carried out in addition to the dispersion step or contemporaneously with the dispersion step. For example, the dispersion of the first hydrated alumina in the acid may take place in the mill. In one embodiment, a ball mill or attrition mill is used for the milling step. One suitable mill is a Union Process Continuous Atritomill, Q-series.

The milling reduces the size of the particles. The median size after milling can be about 4-6μ. In one embodiment, the median size is less than 5μ, e.g., about 4.5μ. In one embodiment, the particle size distribution is bell-shaped with 100% of the milled particles being finer than 20 microns and, in one embodiment, less than 15 microns.

Once the two suspensions are properly dispersed and optionally milled, they are combined, for example in a high intensity mixer, and the mixture spray dried to form carrier particles. Spray drying can be carried out in a spray drier employing a rotary atomizer or a fixed nozzle. A rotary atomizer is preferred for achieving spherical carrier particles. The rotary atomizer is generally located adjacent an upper end of a large cylinder and is rotated about 10,000 to 12,000 rpm. The dispersion exits the atomizer and is contacted by a flow of hot gas (e.g., air at about 500° C.-600° C.) which is injected into an upper end of the cylinder. The resulting generally spherical particles exit the cylinder from a lower outlet and are separated from the hot air in a cyclone separator. The temperature of the vapor leaving the dryer can be from 100° C. to 170° C. At these temperatures, adsorbed water is released from the carrier.

The spherical particles formed are after-dried to reduce the moisture content to less than about 1%, as measured at 110° C. The drying step may be carried out in a drying oven at a temperature of about 150° C. The particles are subsequently heat treated at a temperature over 500° C., such as about 600-1300° C. In one specific embodiment a temperature of about 600-800° C. is used, e.g., about 700° C., for a period of several hours, e.g., about 1-6 hours. The exact time depends to some extent on the amount of material to be fired and the firing device. Static fired powders tend to require more time than rotary fired powders, for example.

At a temperature of about 400-500° C., the hydrated alumina is converted to gamma alumina (γ-alumina). At temperatures of above about 860-900° C., gamma alumina is converted to delta alumina and at even higher temperatures of above about 1000° C., theta alumina and then alpha alumina are formed. The conversion temperature may depend on the source of the alumina. For Fischer-Tropsch catalysts, it is desirable for the alumina to be in the gamma form, since the surface area is generally larger. Thus, where a gamma alumina is desired, the firing temperature is preferably below about 800° C. Where delta, theta and alpha aluminas are acceptable, temperatures in the range of 800°-1300° C. may be used. In general, these temperatures yield lower surface areas, such as from 20-100 m²/g.

Optionally, the thus-formed carrier is post-treated with either a mineral acid or an organic acid, such as nitric acid or acetic acid, at a temperature of from about 0° C. to about 115° C., e.g., 20° C. to 75° C., to reduce the levels of impurities. The acid can be a solution at a concentration of 1-30% by weight or 0.15-5M. In one embodiment, the acid solution is at a concentration of 10-20% by weight or 1.5-3M. For example, a 10% acetic acid solution at 60° C. has been found to reduce Fe₂O₃ levels.

Other post-treatment methods are also contemplated for further reducing impurities. For example, the carrier material can be treated with an ion exchange resin. Cation exchange resins, such as Dowex 50×8, can be used to remove cations, such as sodium. Anions, such as phosphates and sulfates, can be removed with an anion exchange resin. In one embodiment, the carrier is mixed with warm water, optionally with an acid, and passed through a column containing the ion exchange resin. In another embodiment, the carrier is slurried with an ion exchange medium.

The spherical support material produced at moderate firing temperatures (about 600-800° C.) is primarily gamma alumina. Gamma alumina is a stoichiometric oxide of alumina, generally defined as having a cubic crystal structure (space group 227) with a unit cell length of about 7.9 Angstroms. It typically has ICCD XRD pattern Nos. 10-425, 01-1307, and 47-1308. Those skilled in the art will appreciate that other patterns may also be present. In one embodiment, at least 70% of the alumina is in the gamma form, and typically greater than 90% is in the gamma form.

After firing and optional post-firing acid treatment, the support material can have a Nitrogen pore volume of from about 0.5 to 1.0 cc/g, in particular, from 0.7 to 0.9 cc/g, as measured by a Micrometrics Tri-Star 3000 with all samples being degassed at 250° C. for 2 hours. The support material can have a specific surface area of at least 100 m²/g, e.g., from about 100-250, in particular, from about 150 to 200 m²/g, as measured by a Micrometrics Tri-Star 3000 with all samples being degassed at 250° C. for 2 hours. The median pore diameter of the support material can be from about 5 to 50 nm, e.g., about 7-20 nanometers.

The actual values obtained can vary somewhat depending on the hydrated aluminas used in forming the product and on the processing method. For example, in the case of a product derived from Versal 200 as the first alumina and Disperal HP-10 as the second alumina and using nitric acid as the dispersant, typically less than 10% of the pore volume is in pores with a diameter below 5 nm, and less than 10% of the pore volume is in pores with a diameter greater than 50 nm. In one embodiment, less than 40% of the pore volume is in pores with a diameter of less than 10 nm and in one specific embodiment, less than 35% of the pore volume is in pores with a diameter of less than 10 nm.

For comparison, SCFa-140 (a spray dried and calcined alumina made using Sasol alumina), obtainable from Sasol, can have pore volumes in these ranges. However, other properties of the materials, such as attrition resistance, discussed below, are not as favorable as for the present products.

The carrier particles can have a mean diameter (D(50%)), as measured, for example, by Horiba laser light scattering of about 40-100 microns. In one embodiment, D(50%) is about 60 microns. D(10%) for the carrier particles can be about 20 to 30 microns (i.e. 10% of the particles have a diameter of less than or equal to 20-30 microns) and D(90%) can be about 80 to 100 microns (i.e. 90% of the particles have a diameter of less than or equal to 80-100 microns). In one specific embodiment, the particle size distribution of the carrier material is as follows:

D(10%)=27 microns

D(50%)=60 microns

D(90%)=90 microns

The finished carrier is low in impurities. In one embodiment, the percentages of the following impurities, expressed in terms of weight percent are:

| | |
|---|---|
| Na₂O | <0.03 |
| K₂O | <0.01 |
| CaO + MgO | <0.03 |
| SiO₂ | about 0.02, or less |
| Fe₂O₃ | about 0.01 or less |
| TiO₂ | <0.01 |

In one specific embodiment, Na₂₀≦0.02 wt %, CaO<0.01 wt %, and MgO<0.01 wt %. For example, the carrier can have, in terms of weight %:

| | |
|---|---|
| Na₂O | <0.01 |
| K₂O | <0.01 |
| CaO | ≦0.01 |
| MgO | <0.01 |

The finished carrier can have an attrition resistance which is significantly higher than a product prepared from highly dispersible alcohol derived alumina (second hydrated alumina), without a bauxite-derived aluminum hydroxide (first hydrated alumina). For example, the attrition loss, expressed as a percentage, may be measured, for example, according to ASTM D5757-00, which determines the relative attrition characteristics of powdered materials by means of air jet attrition. Lower values correspond to lower attrition loss and thus a higher attrition resistance.

For example, attrition resistances of materials produced solely from the second hydrated alumina may have an attrition loss of about 16% or higher over a period of 4 hours, typically about 16-18%, whereas the products formed from first and second hydrated aluminas, as described herein (e.g., using nitric acid as a dispersant) may have an attrition resistance of about 12% or less, over a period of four hours, e.g., less than about 80% of the % attrition loss of the single hydrated alumina product, and in one embodiment, less than 60%. In one embodiment, the 4 hour attrition loss of the finished carrier described herein is about 10%, or less, and can be about 8% or less, and in one specific embodiment, about 7%. As a result, the present carrier has a much longer useful lifetime when utilized, for example, in a fluidized bed.

The combination of surface area, beneficial pore size, and high attrition resistance of the carrier described herein make the carrier particularly suited to a variety of catalytic applications. In particular, the spray dried carrier predominantly in the form of gamma alumina (e.g., at least 95% gamma alumina, and in one embodiment, at least 99% gamma alumina and in one specific embodiment 100% gamma alumina) can have a surface area of greater than 180 m²/g and a pore volume greater than 0.7 cc/g with less than 35% of its pore volume in pores of less than 10 nm in diameter and can have a % attrition, as measured by ASTM 5757-00 over four hours or even over five hours of less than 10%.

In other embodiments, a spherical support material produced at high firing temperatures (about 800-1300° C.) can contain gamma alumina but may alternatively or additionally include delta, theta, and/or alpha alumina and thus can be referred to as a transition alumina. The high temperature material can have a specific surface area of at least 20 m²/g, e.g., from about 20-100 m²/g, or higher, as measured by a Micrometrics Tri-Star 3000 with all samples being degassed at 250° C. for 2 hours. The four hour attrition loss, as measured according to ASTM 5757-00 can be less than about 15%. Other properties can be similar to those described above for the gamma alumina material produced at lower firing temperatures.

While the embodiments disclosed herein are described with reference to forming a carrier from two forms of hydrated alumina, it is to be appreciated that more than two forms may be employed to form the carrier. These forms may each be dispersed separately. Or, where two or more of the forms have similar dispersion properties, they may be dispersed together. Additionally, while the carrier is described as being formed from at least one alkoxide-derived precursor, it is also contemplated that the carrier may be formed from two forms of hydrated alumina which are not primarily derived from an alkoxide.

A catalyst formed from the carrier may comprise a catalytically effective amount of one or more catalytic agents which is supported by the carrier. Suitable catalytic agents include transition elements selected from Groups IB, IIB, IIIB, IVB, VB, VIIB, VIIB, and VIII of the Periodic Table of Elements, alone or in combination. As examples, Co, Fe, Ni, Ru, Rh, Pd, Ir, and Pt (Group VIII), Ti (Group IVB), Mn (Group VIIB) and Cu (Group IB) are mentioned. In one embodiment, the catalytic agent includes from about 0.1 to about 30% by weight of at least one element selected from transition groups IB, IVB, VIIB, and VIII, of the Periodic Table of Elements and may also comprise up to about 10% by weight of at least one element selected from groups IA and IIA of the Periodic Table of Elements. Examples of these latter, optional elements include K (Group IA) and Mg (Group IIA).

The carrier described herein is suited to use in a variety of applications. One particular use is in Fischer Tropsch reactions, such as gas to liquid (GTL) applications. For example, large quantities of methane, the main component of natural gas, can be used as a starting material for the production of hydrocarbons. The conversion of methane to hydrocarbons is typically carried out in two steps. In the first step, methane is reformed with water or partially oxidized with oxygen to produce carbon monoxide and hydrogen (i.e., synthesis gas or syngas). In a second step, the syngas is converted to hydrocarbons. Catalysts for use in this second step usually contain a catalytically active Group VIII (CAS) metal on a carrier support. In particular, iron, cobalt, nickel, and ruthenium can be used as the catalytically active metals. Additionally, the catalysts can contain one or more promoters, such as rhenium. The spray dried alumina carrier formed by the present method is a particularly suitable carrier material for this catalyst because it combines the benefits of a suitable pore structure and surface area while having low levels of impurities.

The carrier or catalysts produced by the methods described herein have comparatively high mechanical strengths and are therefore particularly suitable for fluidized bed reactions. Fluidized bed reactions can be used, for example, for the rearrangement of cyclohexanoneoxime to give ε-caprolactam, the ammonoxidations of, for example, toluene to give benzonitrile or of propene to give acrylonitrile, the preparation of maleic anhydride from butene or the preparation of aniline from nitrobenzene. The catalyst supports or catalysts formed therefrom, in general, are suitable for use in:

1. Reductions (hydrogenations), for example: hydrogenation of alkynes, for example the selective hydrogenation of acetylene in C₂, C₃, C₄ mixtures, the selective hydrogenation of vinylacetylenes in C₄ fractions and the hydrogenation of butynediol to give butenediol or butanediol, the hydrogenation of alkenes, for example the hydrogenation of unsaturated compounds in the oxo process, aminative hydrogenation, hydrogenation of aromatics, diolefin hydrogenation such as the hydrogenation of diolefins in pyrolysis gasoline, fat hydrogenation, hydrogenative desulfurization such as the hydrogenation of inorganic sulfur compounds, e.g., COS, CS₂, SO₂ and Sₓ to give hydrogen sulfide, hydrogenative refining of aromatics or paraffins, the hydrogenation of organic chlorine compounds, the hydrogenation of aldehydes, carboxylic acids, carboxylic esters, ketones, nitriles, nitro compounds, oximes and oxo products, for example the reduction of nitrobenzene to give aniline, the hydrogenation of carbonyl groups and aromatics, e.g., for producing white oil, the hydrogenation of trimethylquinone to give trimethylhydroquinone, the hydrogenation of adipodinitrile to give hexamethylenediamine, acrylonitrile, NH₃ and the hydrogenation of adipic acid to give hexanediol, the hydrogenation of cyclohexyl hydroperoxide to cyclohexanol, the hydrogenation of citral to give citronellal, the preparation of lilial from dehydrolilial, the removal of NOₓ from waste gases by reduction with ammonia, the preparation of alkanes, olefins, alcohols, aldehydes and/or carboxylic acids from synthesis gas, the hydrogenation of adipodinitrile to give aminocapronitrile, and the aminative hydrogenation of adipic acid to give aminocapronitrile.

2. Oxidations (dehydrogenations), for example: oxidations of alkanes such as the dehydrogenation of ethylbenzene to give styrene or of dimethylcyclohexylamine to give 2,6-dimethylaniline, of alkenes, of alcohols, for example the dehydrogenation of cyclohexanol to give cyclohexanone and the preparation of ethylhexanoic acid and ethylhexanal from ethylhexanol, ammonoxidation such as the preparation of hydrogen cyanide from methane or of o-xylene to give phthalodinitrile, of aromatics, epoxidation, oxidative halogenation, oxidative coupling, oxidation of hydrogen sulfide-containing gases to sulfur by the Claus process, the preparation of vinyl chloride by the oxychlorination process (Stauffer process), the oxidation of hydrogen sulfide and/or organic sulfur compounds to sulfur dioxide, the preparation of sulfuric acid by the contact process from SO₂-containing gases, the preparation of phthalic anhydride from o-xylene and air, the catalytic combustion of hydrocarbons, solvents or CO-contaminated waste gas, the preparation of ethylene dichloride by oxychlorination of ethylene, the oxidation of propene to give acrylic acid, the preparation of methacrylic acid from methacrolein, the preparation of methacrylic acid from isobutyric acid, the dehydrogenation of N,N-dimethylcyclohexylamine to give xylidine and the dehydrogenation of trimethylcyclohexanone to give trimethylphenol, the oxidation of ethylene to ethylene oxide, the oxidation of butadiene to furan, the oxidation of propene to acrolein, and the oxidation of methacrolein to methacrylic acid;

3. Acid- or base-catalyzed reactions, for example: alkoxylations, e.g., of ethylene oxide or propylene oxide, dealkoxylations, e.g., of N-vinylformamide from α-methoxyethylformamide, alkylations, acylations, hydrations, dehydrations, e.g., of aziridine from ethanolamine or of hydrocyanic acid from formamide, aminations, aldol reactions, oligomerizations, polymerizations, polymer-analogous reactions, cyclizations, isomerizations, esterifications, cracking of gaseous hydrocarbons, e.g., of natural gas using steam and possibly CO₂, the oxidation of propene to acrolein, elimination reactions such as N-formylalanine nitrile to give N-vinylformamide, and additions such as methanol or propyne to α-methoxy groups.

Transition aluminas are particularly suited for some reactions, such as hydrogenation reactions, due to their combination of low surface acidity and activity while providing sufficient surface area to disperse adequately the active metals used as catalytic agents and as such yield an active catalyst.

Without intending to limit the scope of the invention, the following Examples demonstrate the preparation and properties of an exemplary carrier material.

### EXAMPLES

### Example 1

15 kg of a bauxite-derived aluminum hydroxide (Versal 200 from UOP), 45 kg of deionized water, and 1.0% by weight, based on the weight of the alumina of a 90% formic acid solution (i.e., a molar ratio of acid to alumina of 0.02) are mixed and ball milled for 4 hours. The resulting slurry has a mean particle size of <5 microns.

As an alternative to Versal 200, HML-02 supplied by Hengmeilin Nanometer Chemical Industrial Material Company of Tianjin, P.R. China, or a pseudoboehmite supplied by Saint-Gobain Grains and Powders of Niagara Falls N.Y. (CAM-90) is used as the bauxite-derived aluminum hydroxide. Properties of these three starting materials, as measured by the processes previously described, are listed in TABLE 2.

TABLE 2

| | | | Saint Gobain |
|---|---|---|---|
| | Versal 200 | HML-02 | CAM 90/10 |
| Impurities | | | |
| Wt % Na₂O | 0.04 | 0.02 | 0.01 |
| Wt % K₂O | <0.01 | <0.01 | <0.01 |
| Wt % CaO | <0.01 | 0.04 | <0.01 |
| Wt % MgO | 0.01 | <0.01 | <0.01 |
| Wt % SiO₂ | 0.04 | 0.04 | 0.03 |
| Wt % Fe₂O₃ | 0.01 | 0.01 | 0.01 |
| Wt % TiO₂ | NA | <0.01 | 0.02 |
| Other Properties | | | |
| Surface Area, m²/g | 300 | 315 | 120 |
| Particle Size (microns) | | | |
| D(10%) | 3 | 3.5 | 5.7 |
| D(50%) | 11 | 9.4 | 60 |
| D(90%) | 20 | 19.9 | 161 |
| Phase Composition | Boehmite | Bayerite and | Boehmite |
| XRD | | Boehmite | |

NA indicates that this result has not been measured. ND indicates not detected.

### Example 2

4 kg of a highly dispersible alumina (Pural 14 from Sasol), are combined with 12 kg of deionized water and 1% by weight, based on the weight of the alumina of 25 wt % formic acid (i.e., a molar ratio of acid to alumina of 0.02) and mixed with a high intensity mixer for 4 hrs. The resulting slurry has a mean particle size of about 8 microns.

### Example 3

The slurries from Examples 1 and 2 (based on Versal 200 and Pural 14) are combined using a high intensity mixer and subsequently spray dried to form spherical granules. The particles are dried at 150° C. in a drying oven and subsequently heat treated at 700° C. for 2 hours. The resulting powder (product 1) has the following properties:

| | | |
|---|---|---|
| Surface area: | 210 | m²/g |
| Nitrogen pore Volume: | 0.85 | m²/g |
| Median Pore Diameter | 13 | nm |
| % Na₂O | 200 | ppm (0.02 wt %) |
| % K₂O | <100 | ppm |
| % CaO | 100 | ppm |
| % MgO | <100 | ppm |
| % SiO₂ | 200 | ppm |
| % Fe₂O₃ | 100 | ppm |
| % TiO₂ | <100 | ppm |

The sodium oxide content was thus intermediate that measured for the starting materials.

### Example 4

The sintered powder from Example 3 is reslurried in deionized water at 50° C. and stirred for 1 hour. The resulting powder has the following impurity levels:

| | | |
|---|---|---|
| % Na₂O | <100 | ppm |
| % K₂O | <100 | ppm |
| % CaO | 100 | ppm |
| % MgO | <100 | ppm |
| % SiO₂ | 200 | ppm |
| % Fe₂O₃ | 200 | ppm |

| | |
|---|---|
| % TiO₂ | None Detected |

The sodium oxide impurity level measured was thus lower than that measured for either of the starting materials.

### Example 5

TABLE 3 below shows results for carriers formed according to the procedures described in Examples 1-3 from three different bauxite-based aluminas combined with an alkoxide-base alumina (Pural 14). Product 1 was formed as described above. Product 2 was derived from Veral and Pural 14 using the amounts and procedures of Examples 1-3. Product 3 was derived from CAM 90/10, supplied by Saint-Gobain Grains and Powders of Niagara Falls and Pural 14 using the amounts and procedures of Examples 1-3. The attrition resistance of the spray dried and calcined powders was determined throughout using ASTM method D5757-00. The scope of this test method covers the determination of the relative attrition characteristics of powdered catalysts by means of air jet attrition. It is applicable to spherically or irregularly shaped particles which range in size between 10 and 180 μm. This test method is intended to provide information concerning the ability of a powdered catalyst to resist particle size reduction during use in a fluidized environment.

It should be noted that the first 1 hr of the Air Jet test is a conditioning phase and while generally reported, it is not considered to accurately represent the % attrition. During the first hour the <20 micron particles already present in the powder are removed. During the next 4 hrs any new <20 micron particles are consider generated by attrition.

TABLE 3

| | Product 1 | Product 2 | Product 3 |
|---|---|---|---|
| | Versal | HML-02/Pural | Saint-Gobain |
| | 200/Pural 14 | 14 Based | CAM 90/10/Pural |
| | Based Carrier | Carrier | 14 based Carrier |
| Calcination Temperature | 700° C. | 700° C. | 600° C. |
| Wt % Na₂O | <0.01 | <0.01 | NA |
| Wt % K₂O | <0.01 | <0.01 | NA |
| Wt % CaO | 0.02 | 0.03 | NA |
| Wt % MgO | 0.01 | <0.01 | NA |
| Wt % SiO₂ | 0.06 | 0.07 | NA |
| Wt % Fe₂O₃ | 0.03 | ND | NA |
| Wt % TiO₂ | NA | NA | NA |
| Surface Area, m²/g | 210 | 180 | 167 |
| Nitrogen Pore | 0.76 | | 0.64 |
| Volume, cc/g | | | |
| Nitrogen Pore | 123 | | 148 |
| Diameter, Angstroms | | | |
| Particle Size, microns | | | |
| D(10%) | 27 | | 18 |
| D(50%) | 60 | | 59 |
| D(90%) | 90 | | 101 |
| Phase Composition, XRD | Gamma alumina | | |
| 1 Hr Attrition Loss, % | 16 | 27 | 25 |
| 4 Hr Attrition Loss, % | 32 | 51 | 50 |

### Example 6

15 kg of bauxite-derived aluminum hydroxide (Versal 200 from UOP), 45 kg of deionized water, and 600 gram of 70 wt. % nitric acid are mixed with an impeller mixer and milled using a Union Process Q-2 mill until the average particle size as measured by laser light scattering is less than 5 microns, a time of approximately 4 hrs. The pH of the slurry is maintained between 4 and 5 by the additions of more nitric acid, as needed. To this milled slurry is added 4.5 kg of a highly dispersible alumina (Pural HP 10, Sasol) and the slurry is milled for an additional hour to give a homogeneous slurry. The pH of the slurry is adjusted to between 3 and 4 with additional nitric acid. At this point the molar ratio of acid to alumina, (Al₂O₃) is approximately 0.04 but can be between 0.015 and 0.06.

The slurry is subsequently spray dried to form spherical granules. The granules are dried at 150° C. in a drying oven and subsequently heat treated at 700° C. for 2 hours.

### Example 7

15 kg of bauxite-derived aluminum hydroxide (Versal 200 from UOP), 45 kg of deionized water, and 600 gram of 70 wt. % nitric acid are mixed with an impeller mixer and milled using a Union Process Q-2 mill until the average particle size as measured by laser light scattering is less than 5 microns, approximately 4 hrs. The pH of the slurry is maintained between 4 and 5 by the additions of more nitric acid, as needed. To this milled slurry is added 4.5 kg of a highly dispersible alumina (Catapel B, from Sasol) and the slurry is milled for an additional hour to give a homogeneous slurry. The pH of the slurry is adjusted to between 3 and 4 with additional nitric acid. At this point the molar ration of acid to alumina, Al₂O₃, is approximately 0.04 but can be between 0.015 and 0.06.

The slurry is subsequently spray dried to form spherical granules. The granules are dried at 150° C. in a drying oven and subsequently heat treated at 700° C. for 2 hours.

### Example 8

15 kg of bauxite-derived aluminum hydroxide (Versal 200 from UOP), 45 kg of deionized water and 600 gram of 70 weight % nitric acid are mixed with an impeller mixer and milled using a Union Process Q-2 mill until the average particle size as measured by laser light scattering is less than 5 microns, approximately 4 hrs. The pH of the slurry is maintained between 4 and 5 by the additions of more nitric acid, as needed. To this milled slurry is added 4.5 kg of CAM 90/10 supplied by Saint-Gobain Grains and Powders of Niagara Falls and the slurry is milled for an additional hour to give a homogeneous slurry. The pH of the slurry is adjusted to between 3 and 4 with additional nitric acid. At this point, the molar ration of acid to alumina, Al₂O₃, is approximately 0.04 but can be between 0.015 and 0.06.

The slurry is subsequently spray dried to form spherical granules. The granules are dried at 150° C. in a drying oven and subsequently heat treated at 700° C. for 2 hours.

### Example 9

Table 4 shows physical properties of the products of Examples 6, 7, and 8 as well as those of two comparative products derived from highly dispersible alumina (Sasol Puralox SCFa-140 and SCFa-140 High Ti, which are spray dried and calcined aluminas made using Sasol alumina) without bauxite-derived aluminum hydroxide.

TABLE 6
Physical Property Comparison

| | | SCFa-140 | | | |
|---|---|---|---|---|---|
| | SCFa-140 | High Ti | Example 6 | Example 7 | Example 8 |
| Calcination | As | As | 700° C. | 700° C. | 700° C. |
| Temperature | Received | Received | | | |
| Wt % Na₂O | ND | ND | <0.01 | <0.01 | <0.01 |
| Wt % K₂O | ND | ND | <0.01 | <0.01 | <0.01 |
| Wt % CaO | ND | ND | 0.02 | 0.03 | 0.02 |
| Wt % MgO | ND | ND | 0.01 | <0.01 | 0.01 |
| Wt % SiO₂ | <0.01 | <0.01 | 0.06 | 0.07 | 0.06 |
| Wt % Fe₂O₃ | <0.01 | <0.01 | ND | ND | ND |
| Wt % TiO₂ | 0.05 | 0.1 | NA | NA | NA |
| Surface Area, | 156 | 150 | 230 | 266 | 205 |
| m²/g | | | | | |
| Nitrogen Pore | 0.46 | 0.5 | 0.7 | .61 | 0.57 |
| Volume, cc/g | | | | | |
| Nitrogen Pore | 95 | 98 | 100 | 86 | 90 |
| Diameter, | | | | | |
| Angstroms | | | | | |

Particle Size, microns

| | | | | | |
|---|---|---|---|---|---|
| D(10%) | 11 | 10 | 41 | 44 | 40 |
| D(50%) | 40 | 41 | 60 | 63 | 59 |
| D(90%) | 72 | 75 | 90 | 97 | 82 |
| Phase | Gamma | Gamma | Gamma | Gamma | Gamma |
| Composition | alumina | alumina | alumina | alumina | alumina |
| XRD | | | | | |
| 1 Hr Attrition | 22 | 22.5 | 3 | 3 | 4 |
| Loss, % | | | | | |
| 4 Hr Attrition | 18 | 16 | 7 | 7 | 7 |
| Loss, % | | | | | |

As can be seen, the 4 hour attrition losses of the spray dried products of Examples 6-9 are substantially lower than for the corresponding commercial products which lack a portion of bauxite-derived aluminum hydroxide.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

1. A method of forming a carrier material comprising:
forming a dispersion of a first hydrated alumina and a second hydrated alumina, different from the first hydrated alumina, in a liquid dispersant by dispersing said first hydrated alumina in said liquid dispersant to form a first dispersions milling the first hydrated alumina to reduce its particle size and adding the second hydrated alumina to the first dispersion;
spray drying the dispersion to form particles; and
heating the spray dried particles to form the carrier material.

2. The method of claim 1, wherein the first hydrated alumina differs from the second hydrated alumina in at least method of formation.

3. (canceled)

4. The method of claim 1, wherein the liquid dispersant includes an acid selected from mineral acids, organic acids, and combinations thereof.

5. The method of claim 4, the acid includes at least one of formic acid and nitric acid.

6. The method of claim 1, wherein the second hydrated alumina has a lower sodium content, measured as the oxide, than the first hydrated alumina.

7. The method of claim 6, wherein the first hydrated alumina has a sodium content, measured as the oxide, of at least 100 ppm, and the second hydrated alumina has a sodium content, measured as the oxide, of less than 50 ppm.

8. The method of claim 6, wherein the first hydrated alumina and the second hydrated alumina are used at a weight ratio of from 1:99 to 99:1.

9. The method of claim 8, wherein the first hydrated alumina and the second hydrated alumina are used at a weight ratio of about 80:20.

10. The method of claim 1, further comprises deriving:
the first hydrated alumina from an alkali aluminate; and
the second hydrated alumina from an aluminum material comprising at least 99% by wt. aluminum.

11. The method of claim 1, further comprises forming:
the first hydrated alumina is formed by a process which includes:
a) dissolution of alumina trihydrate in an acid or base and
b) seeding the product of step) with boehmite seeds: and
forming the second hydrated alumina is formed by a process which includes:
converting the aluminum metal to an alkoxide and hydrolyzing the alkoxide to form pseudoboehmite.

12. The method of claim 1, wherein:
the first hydrated alumina has:
a surface area of at least 100 m²/g, and
a pore volume of 0.4 to 2 cc/gm: and
the second hydrated alumina has:
a surface area of 100 m²/g,
a pore volume of at least 0.5 cc/g, and
a purity, expressed in terms of alumina as a percentage of all oxides present, which is higher than the first hydrated alumina.

13. The method of claim 1, further including, after the step of heating:
treating the carrier material to reduce a level of at least one impurity.

14. The method of claim 1, wherein the step of heating includes heating to a temperature of at least about 600° C.

15. The method of claim 1, wherein the step of heating includes heating to a temperature of less than about 800° C.

16. A carrier formed by the method of claim 1.

17. A catalyst comprising the carrier material of claim 16, and further comprising:
a catalytic amount of at least one catalytic agent.

18. The catalyst of claim 17, wherein the catalytic agent comprises:
from about 0.1% to about 30% by weight of the catalyst of at lest one element selected from transition groups IB, IIIB, IVB, VIIB, and VIII of the Periodic Table of Elements; and
from 0% to about 10% by weight of the catalyst of at least one element selected from groups Ia and IIA of the Periodic Table of Elements.

19-38. (canceled)
